(19) United States
(12) Patent Application Publication
(10) Pub. No.: US 2008/0005011 A1
(43) Pub. Date: Jan. 3, 2008

(54) MANAGING INFORMATION SOLICITATIONS ACROSS A NETWORK

(75) Inventors: Christopher A. Meek, Kirkland, WA (US); David M. Chickering, Bellevue, WA (US); Timothy S. Paek, Sammamish, WA (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/424,120

(22) Filed: Jun. 14, 2006

(51) Int. Cl. G06Q 40/00

(52) U.S. Cl. 705/37

(57) ABSTRACT

A service manager manages information solicitations in a network of users. An information solicitation is posted that is received from an information consumer. The posted information solicitation is provided to at least a portion of the users of the network for auction. The information solicitation includes a request to engage in a real-time communication with an information provider about a particular subject. Bids are received from a plurality of information providers. The bids are provided to the information consumer for selection. The information consumer is connected with a selected one of the plurality of information providers.

### BACKGROUND

Many times, users of a network-based environment desire to obtain goods from other users of the environment and/or obtain information from other users of the environment. Users of these network-based environments are willing to pay other users of the environment a fee in exchange for the good and/or the information.

Auction type network-based environments allow users to bid on various products. Generally, the highest bid is selected by the offeror of the product. Upon selection, a contract is formed between the offeror and the selected bidder. To perform the contract, the offeror sends the product to the selected bidder and the selected bidder pays the amount of the selected bid to the offeror. These auction type network-based environments help offerors find bidders. These auction type network-based environments also provide for secure transactions between the offeror and the bidder.

Other types of network-based environments also exist that provide users with help finding information and answering questions. In these environments, a user submits a question and sets a fee they are willing to pay to have a researcher answer their submitted question. A researcher, who is generally an experienced web researcher with strong communication skills and often has expertise in various fields, answers the question in exchange for the fee set by the user.

Frequently, the information that a user in a network-based environment may want to obtain from other users of the network-based environment is not in the form of a question. A user may find that gathering this type of information from other users of the system is more practical and valuable via a real-time discussion. However, none of the above-discussed network-based environments are capable of allowing a user to discuss a subject with another user.

The discussion above is merely provided for general background information and is not intended to be used as an aid in determining the scope of the claimed subject matter.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

A service manager manages information solicitations in a network of users. The service manager manages an information solicitation by posting the information solicitation received from an information consumer such that it is available to at least a portion of the users of the network. The information solicitation is a request made by the information consumer to engage in a real-time communication with an information provider about a subject. The service manager receives bids from a plurality of information providers. The service manager provides the bids to the information consumer for selection. After the information consumer selects a bid, the service manager instructs a connection module to connect the information consumer with the information provider. The connection is a real-time connection that can be made using an Internet Protocol interface or a telephone system interface.

### BRIEF DESCRIPTION OF THE DRAWINGS

FIG. 1 illustrates a network-based service environment.

FIG. 2 illustrates an exemplary communication architecture having a service agent.

FIG. 3 is a flowchart illustrating a method of managing information solicitations in a network-based service environment.

FIG. 4 is a flowchart illustrating a method of soliciting information in a network-based service environment.

FIG. 5 is an exemplary computing system for implementing a service agent and/or a client device.

FIG. 6 is an exemplary mobile device for implementing a client device.

### DETAILED DESCRIPTION

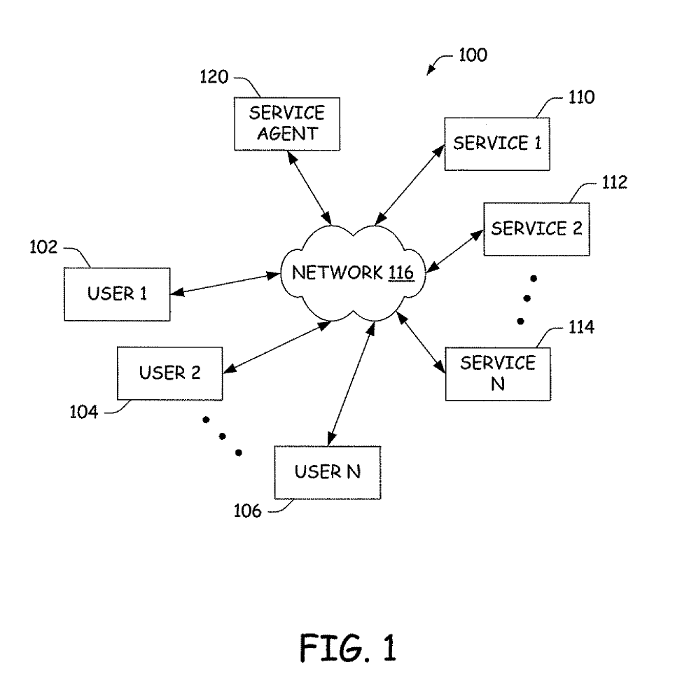

FIG. 1 is a block diagram of a network-based service environment 100. Service environment 100 includes a plurality of users, for example user 102, user 104 and user 106. Each of the plurality of users 102, 104 and 106 can access a plurality of services, for example services 110, 112 and 114 through a network 116. Additionally, each of the users 102, 104 and 106 can connect with other users through network 116. Additionally, users 102, 104 and 106 can connect with service agent 120 through network 116. Service agent 120 can store information related to each of the users 102, 104 and 106 as well as facilitate communication among each of the users 102, 104, 106 and each of the services 110, 112 and 114. Services 110, 112 and 114 can provide various sources of information for access by users 102, 104 and 106. For example, information can relate to stock quotes, weather, travel information, news, music, advertisements, etc. Service agent 120 can include personal information for each of the users 102, 104 and 106 to customize access to services 110, 112 and 114. For example, user 102 may wish to only receive particular stock quotes from service 112. Service agent 120 can store this information.

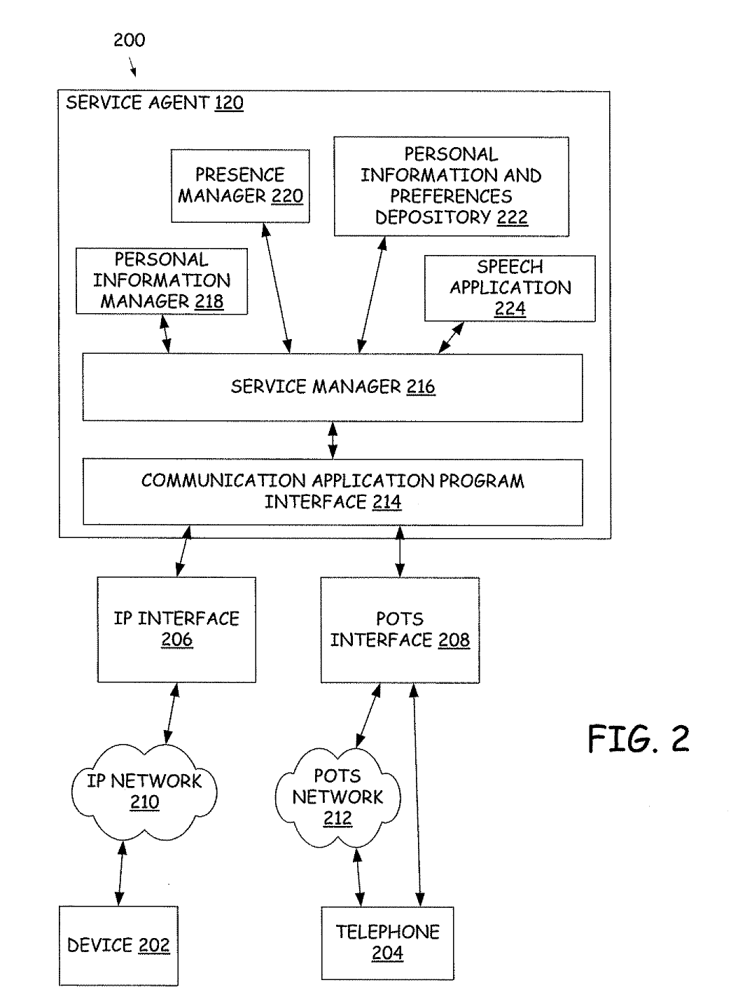

FIG. 2 illustrates exemplary communication architecture 200 with a service agent 120 as discussed above. Agent 120 receives communication requests and messages from a user (for example users 102, 104 and 106) and performs tasks based on the requests and messages. The messages can be routed to a destination. The user can access agent 120 through any device, telephone, remote personal information manager, etc. that connects to agent 120. Information from the user can take many forms including web-based data entry, real time voice (for example from a simple telephone or through a voice over Internet protocol (VOIP) source), real time text (such as instant messaging (IM)), non-real time voice (for example a voicemail message) and non-real time text (for example through short message service (SMS) or email). Tasks are automatically performed by agent 120, for example speech recognition, accessing services, scheduling a calendar, voice dialing, managing contact information, managing messages, call routing and interpreting a caller identification.

In one embodiment, service agent 120 can be implemented on a general purpose computer. Agent 120 represents a single point of contact for a user or a group of users. Thus, if a person wishes to contact the user or group of users associated with agent 120, communication requests and messages are passed through agent 120. In this manner, the person need not have all contact information for another user or group of users. The person only needs to contact agent 120, which can handle and route incoming communication requests and messages. Additionally, agent 120 is capable of initiating a dialog with the person, if the user or group of users is unavailable.

A user can contact agent 120 through a number of different modes of communication. Generally, agent 120 can be accessed through a client device, such as computing device 202 (for example a mobile device, laptop or desktop computer, which herein represents various forms of computing devices having a display screen, a microphone, a camera, a touch sensitive panel, etc., as required based on the form of input), or through a phone 204 wherein communication is made audibly or through tones generated by phone 204 in response to keys depressed and wherein information from agent 120 can be provided audibly back to the user.

More importantly, though, agent 120 is unified in that whether information is obtained through device 202 or phone 204, agent 120 can support either mode of operation. Agent 120 is operably coupled to multiple interfaces to receive communication messages. IP interface 206 receives information using packet switching technologies, for example using TCP/IP. POTS (Plain Old Telephone System, also referred to as Plain Old Telephone Service) interface 208 can interface with any type of circuit switching system including a Public Switch Telephone Network (PSTN), a private network (for example a corporate Private Branch Exchange (PBX)) and/or combinations thereof. Thus, POTS interface 208 can include an FXO (Foreign Exchange Office) interface and an FXS (Foreign Exchange Station) interface for receiving information using circuit switching technologies. IP interface 206 and POTS interface 208 can be embodied in a single device such as an analog telephony adapter (ATA). Other devices that can interface and transport audio data between a computer and a POTS can be used, such as “voice modems” that connect a POTS to a computer using a telephone application program interface (TAPI).

In this manner, agent 120 serves as a bridge between the Internet domain and the POTS domain. In one example, the bridge can be provided at an individual personal computer with a connection to the Internet. Additionally, agent 120 can operate in a peer-to-peer manner with any suitable device, for example device 202 and/or phone 204. Furthermore, agent 120 can communicate with one or more other agents and/or services.

As illustrated in FIG. 2, device 202 and agent 120 are commonly connected, and separately addressable, through a network 210, herein a wide area network such as the Internet. It therefore is not necessary that device 202 and agent 120 be physically located adjacent each other. Device 202 can transmit data, for example speech, text and video data, using a specified protocol to IP interface 206. In one embodiment, communication between client 202 and IP interface 206 uses standardized protocols, for example TCP/IP (Transmission Control Protocol/Internet Protocol) and SIP with RTP (Session Initiator Protocol with Realtime Transport Protocol).

Access to agent 120 through phone 204 includes connection of phone 204 to a wired or wireless telephone network 212 that, in turn, connects phone 204 to agent 120 through a FXO interface. Alternatively, phone 204 can directly connect to agent 120 through a FXS interface.

Both IP interface 206 and POTS interface 208 connect to agent 120 through a communication application program interface (API) or communication module 214. One implementation of communication API 214 is Microsoft Real-Time Communication (RTC) Client API, developed by Microsoft Corporation of Redmond, Wash. Another implementation of communication API 214 is the Computer Supported Telecommunication Architecture (ECMA-269/ISO 120651), or CSTA, an ISO/ECMA standard. Communication API 214 can facilitate multimodal communication applications, including applications for communication between two computers, between two phones and between a phone and a computer. Communication API 214 can also support audio and video calls, text-based messaging and application sharing. Thus, agent 120 is able to initiate communication to device 202 and/or phone 204. Alternatively, another agent and/or service can be contacted by agent 120.

To unify communication control for POTS and IP networks, agent 120 is able to translate POTS protocols into corresponding IP protocols and vice versa. Some of the translations are straightforward. For example, agent 120 is able to translate an incoming phone call from POTS into an invite message (for example a SIP INVITE message) in the IP network, and a disconnect message (for example a SIP BYE message), which corresponds to disconnecting a phone call in POTS.

However, some of the IP-POTS translations involve multiple cohesive steps. For example, a phone call originated in POTS may reach the user on the IP network with agent 120 using an ATA connected to an analog phone line. The user may direct the agent 120 to transfer the communication to a third party reachable only through a POTS using a refer message (for example a SIP REFER message). The ATA fulfills the intent of the SIP REFER message using call transfer conventions for the analog telephone line. Often, call transfer on analog phone lines involves the following steps: (1) generating a hook flash, (2) waiting for a second dial tone, (3) dialing the phone number of the third party recipient, and (4) detecting the analog phone call connection status and generating corresponding SIP messages (e.g., a ringing connection in an analog phone corresponds to a REFER ACCEPTED and a busy tone to a REFER REJECTED, respectively).

Agent 120 also includes a service manager 216, a personal information manager (PIM) 218, a presence manager 220, a personal information and preferences depository 222 and a speech application 224. Service manager 216 includes logic to handle communication requests and messages from communication API 214. This logic can perform several communication tasks including answering, routing and filtering calls, recording voice and video messages, analyzing and storing text messages, arranging calendars, schedules and contacts as well as facilitating individual and conference calls through both IP interface 206 and POTS interface 208.

Service manager 216 also can define a set of rules for which to contact a user and interact with users connecting to agent 120 via communication API 214. Rules that define how to contact a user are referred to as “Find Me/Follow Me” features for communication applications. For example, a user associated with agent 120 can identify a home phone number, an office phone number, a mobile phone number and an email address within personal information and preferences depository 222 for which agent 120 can attempt to contact the user. Additionally, persons contacting agent 120 can have different priority settings such that, for certain persons, calls can always be routed to the user.

Service manager 216 can also perform various natural language processing tasks. For example, service manager 216 can access speech application 224 that includes a recognition engine used to identify features in speech input. Recognition features for speech are usually words in the spoken language. In one particular example, a grammar can be used to recognize text within a speech utterance. As is known, recognition can also be provided for handwriting and/or visual inputs.

Service manager 216 can use semantic objects to access information in PIM 218. As used herein, “semantic” refers to a meaning of natural language expressions. Semantic objects can define properties, methods and event handlers that correspond to the natural language expressions.

A semantic object provides one way of referring to an entity that can be utilized by service manager 216. A specific domain entity pertaining to a particular domain application can be identified by any number of different semantic objects with each one representing the same domain entity phrased in different ways.

The term semantic polymorphism can be used to mean that a specific entity may be identified by multiple semantic objects. The richness of the semantic objects, that is the number of semantic objects, their interrelationships and their complexity, corresponds to the level of user expressiveness that an application would enable in its natural language interface. As an example of polymorphism “John Doe”, “VP of NISD”, and “Jim's manager” all refer to the same person (John Doe) and are captured by different semantic objects PersonByName, PersonByJob, and PersonByRelationship, respectively.

Semantic objects can also be nested and interrelated to one another including recursive interrelations. In other words, a semantic object may have constituents that are themselves semantic objects. For example, “Jim's manager” corresponds to a semantic object having two constituents: “Jim” which is a “Person” semantic object and “Jim's Manager” which is a “PersonByRelationship” semantic object. These relationships are defined by a semantic schema that declares relationships among semantic objects. In one embodiment, the schema is represented as a parent-child hierarchical tree structure. For example, a “SendMail” semantic object can be a parent object having a “recipient” property referencing a particular person that can be stored in PIM 218. Two example child objects can be represented as a “PersonByName” object and a “PersonByRelationship” object that are used to identify a sender of a mail message from PIM 218.

Using service manager 216, PIM 218 can be accessed based on actions to be performed and/or semantic objects. As appreciated by those skilled in the art, PIM 218 can include various types and structures of data that can manifest themselves in a number of forms such as, but not limited to, relational or objected oriented databases, Web Services, local or distributed programming modules or objects, XML documents or other data representation mechanism with or without annotations, etc. Specific examples include contacts, appointments, text and voice messages, journals and notes, audio files, video files, text files, databases, etc. Agent 120 can then provide an output using communication API 214 based on the data in PIM 218 and actions performed by service manager 216.

PIM 218 can also include an indication of priority settings for particular contacts. The priority settings can include several levels of rules that define how to handle communication messages from a particular contact. For example, one contact can have a high priority (or VIP) setting in which requests and/or messages are always immediately forwarded to the user associated with agent 120. Contacts with a medium priority setting will take a message from the contact if the user is busy and forward an indication of a message received to the user. Contacts with a low setting will have messages taken that can be access by the user at a later time. In any event, numerous settings and rules for a user's contacts can be set within PIM 218, which are not limited to the situations discussed above.

Presence manager 220 includes an indicator of a user's availability. For example, a presence indicator can be “available”, “busy”, “stepped out”, “be right back”, “on the phone”, or “offline”. Presence manager 220 can interact with service manager 216 to handle communication messages based on the indicator. In addition to the presence indicators identified above, presence manager 220 also includes a presence referred to as “delegated presence”.

When presence manager 220 indicates that presence is delegated, agent 120 serves as an automatic message handler for a user or group of users. Agent 120 can automatically interact with persons wishing to contact the user or group of users associated with agent 120. For example, agent 120 can route an incoming call to a user's cell phone, or prompt a person to leave a voicemail message. Alternatively, agent 120 can arrange a meeting with a person based on information contained in a calendar of the PIM 218. When agent 120 is associated with a group of users, agent 120 can route a communication request in a number of different ways. For example, the request can be routed based on a caller identification of a person, based on a dialog with the person or otherwise.

Personal information and preferences depository 222 can include personal information for a particular user including contact information such as email addresses, phone numbers and/or mail addresses. Additionally, depository 222 can include information related to audio and/or electronic books, music, personalized news, weather information, traffic information, stock information and/or services that provide these specific types of information. Additionally, depository 222 can include customized information to drive speech application 224. For example, depository 222 can include acoustic models, user voice data, voice services that a user wishes to access, a history of user behavior, models that predict user behavior, modifiable grammars for voice services, personal data such as log-in names and passwords and/or voice commands.

In one embodiment, a user of the network-based service environment 100, such as user 102, 104 or 106 (FIG. 1), can be an information consumer, an information provider or both. An information consumer is a user who desires to obtain information or solicit information from an expert about a particular subject. An information provider is a user who is an expert in one or more subjects and is willing to provide information to the information consumer in exchange for a fee. Both the information provider and the information consumer participate in a real-time communication to provide the information and to obtain the information. Information consumers and information providers in the network-based service environment 100 utilize service manager 216 to manage information solicitations that are requested by an information consumer and obtained from an information provider.

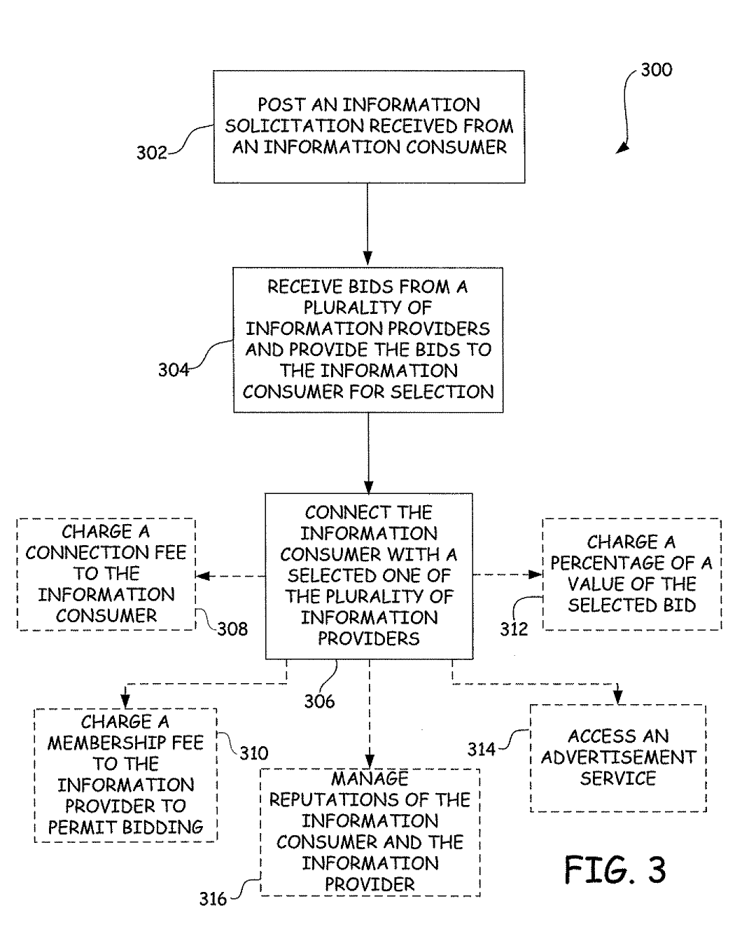

FIG. 3 is a flowchart illustrating a method of managing information solicitations in network-based service environment 100 (FIG. 1). In accordance with an embodiment, service manager 216 (FIG. 1) is configured to perform the steps illustrated in FIG. 3. At block 302, service manager 216 posts an information solicitation received from an information consumer, such as one of users 102, 104 and 106 (FIG. 1). The information solicitation is provided to at least a portion of the users of network-based service environment 100 for auction. The information solicitation includes a request to engage in a real-time communication with an information provider about a particular subject.

In one embodiment, the information solicitation received from the information consumer can include at least one constraint. Constraints included with the information solicitation provide the information consumer with a mechanism to limit different types of information providers that can bid on the information solicitation.

For example, the information consumer can limit the location of where the information provider resides. This type of constraint is particular helpful if the subject of the information solicitation relates to a particular region or locality. The information consumer can limit the information solicitation to the information consumer's own social network that is stored in personal information and preferences depository 222 (FIG. 1). The information consumer can limit the information solicitation to information providers that work for a particular company. The information consumer can limit the information solicitation to accept only certain kinds of payment terms. Example payment terms include an amount and a payment method (i.e. a flat payment, a fee rate payment). The information consumer can also include time constraints on the information solicitation. Examples of time constraints include restricting the bid to be open for a given period of time and restricting the real-time connection to be performed at a given period of time or during a range of times. These constraints employed by the information consumer and applied to the information solicitation are used by service manager 216. Service manager 216 posts the information solicitation but then only allows those information providers in networked-based service environment 100 to bid on information solicitations that meet the constraints of the information solicitation.

In another embodiment, information providers can limit the information solicitations that they receive by including constraints in personal information and preferences depository 222. Constraints included in personal information and preferences depository 222 provide the information provider with a mechanism to limit different types of information solicitations that the information provider will consider or limit information solicitations authored by particular information consumers. Therefore, the information provider is given only those information solicitations in which the information provider would consider bidding on and not an excessive amount of information solicitations that the information provider would never bid on.

For example, the information provider can limit information solicitations that the information provider will consider based on the geographic location of the information consumer of the information solicitation. This type of constraint is particular helpful if the information provider is an expert in a particular region or locality. The information provider can limit information solicitations that the information provider will consider based on the information provider's own social network that is stored in personal information and preferences depository 222 (FIG. 1). The information provider can limit information solicitations that the information provider will consider based on where the information consumer of the information solicitation works. The information provider can limit information solicitations that the information provider will consider based on payment terms. For instance, an information provider can be unwilling to communicate with an information consumer for less than $10/hour. The information consumer can also limit information solicitations that the information provider will consider based on time constraints in the information solicitation. For instance, an information provider can be unwilling to communicate with an information consumer on Sundays. Service manager 216 uses these constraints that are employed by the information provider and applied to the information solicitations that the information provider will consider. Service manager 216 sends only certain information solicitations to certain information providers that will consider the information solicitations. In a sense, service manager 216 matches an information consumer with the best information providers available and service manager 216 matches an information provider with the best available information solicitations. In addition, service manager 216 can remember information providers that particular information consumers have used in the past. This memory function allows service manager 216 to easily match information consumers with previously used information providers.

At block 304, service manager 216 receives bids from a plurality of information providers and provides those bids to the information consumer for selection. The bids received from the information providers can be in the form of a variety of different payment methods. For example, the information provider can bid to engage in a real-time communication with the information consumer for a particular rate (i.e. $1.00/minute, $0.90/minute, $0.50/minute, etc.). In another example, the information provider can bid to engage in a real-time communication with the information consumer for a flat fee (i.e. $20, $10, $5, etc.). These fees reflect how the information provider is willing to be compensated in exchange for partaking in a real-time communication with the information consumer about a particular subject.

At block 306, the service manager 216 instructs the connection module 214 to connect the information consumer with a selected one of the plurality of information providers. As previously discussed, the connection is a real-time communication. As previously discussed, real-time communication can be connected through a POTS interface 208 which would allow the information consumer and the information provider to have a real-time voice conversation on a telephone or cell phone. As also previously discussed, real-time communication can be connected through an IP interface 206. For example, IP interface 206 can provide real-time voice through a voice over Internet protocol (VOIP) source, a real time text using instant messaging (IM) or real time video and audio, such as videoconferencing.

Connection module 214 connects the information consumer with the selected one of the plurality of information providers in accordance with constraints negotiated by the information consumer and the selected one of the plurality of information providers. For example, the information provider can let the information consumer book a time in their calendar. If the consumer needs the time immediately and is willing to pay a price for that immediacy, then the information consumer can override other appointments that the information provider may already have. In another example, both the consumer and the provider can specify their available times and service agent 216 can assist in finding times where both the information consumer and the information provider have available.

In addition, each real-time connection made by the connection module 214 can be an anonymous connection. An anonymous connection allows both the information consumer and the information provider to be unaware of the identification of each other. Although the information consumer and the information provider are registered with service agent 120 and identified in personal information and preferences depository 222, connection module 214 allows the information consumer and the information provider to connect while being unaware of each others identification.

Blocks 308 through 316 illustrate optional additional methods for the method illustrated in blocks 302 through 306. Blocks 308, 310 312 and 314 provide methods for service manager 216 to be compensated for allowing information consumers and information providers to use the system. At block 308, service manager 216 charges a connection fee for information consumers. The connection fee is charged prior to the information consumer being connected with the information provider. At block 310, service manager 216 charges information providers with a membership fee. The membership fee allows information providers to use the system to consider bids and to submit bids. At block 312, service manager 216 charges a percentage of a value of the selected bid. A percentage fee allows information consumers and information providers to use the system. At block 314, service manager 216 accesses an advertisement service, such as service 110, 112 or 114 (FIG. 1) to feed to the information provider and the information consumer while information solicitation are posted and auctioned, while bids are received and provided and while the information consumer and information provider are connected. Advertisements can be audio, visual or audiovisual depending on the device (i.e. computing device or telephone) the information provider or information consumer is using to access the system.

At block 316, service manager 216 manages reputations of the information consumer and the information provider. To manage reputations of the information consumer and the information provider, service manager 216 collects an information consumer review from the information provider after disconnection from the real-time communication made by connection module 214. Service manager 216 also collects an information provider review from the information consumer after disconnection from the real-time communication made by connection module 214. Service manager 216 can provide incentives to information consumers and information providers who submit information provider reviews and information consumer reviews. Service manager 216 uses the information consumer reviews to evaluate information consumers and assign each information consumer a reputation value. Service manager 216 uses the information provider reviews to evaluate information providers and assign each information provider a reputation value. The reviews aid in preventing users from abusing the system and also aid information consumers and information providers in making better selections and bids.

Reputation values of information consumers and information providers are revealed to users of the network-based service environment 100. Reputation values of information providers aid information consumers in selecting bids. For example, an information consumer is given two bids to choose from. The first bid is for $1/minute from an information provider that has an average reputation value. The second bid is for $2/minute from an information provider with a high reputation value. The information consumer may decide not to select the lowest bid because the highest bid is from an information provider that has a high reputation. Reputation values of information consumers aid in information providers making a bid on an information solicitation. For example, an information provider receives two information solicitations from two different information consumers. The first information solicitation requests information about fixing a leaky faucet. The first information solicitation is from an information consumer with an average reputation. The second information solicitation requests information about a fixing a leaky faucet. The second information solicitation is from an information consumer with a high reputation. The information provider may decide to select the second information solicitation because it is from an information consumer with a higher reputation. Otherwise, the information solicitations are identical.

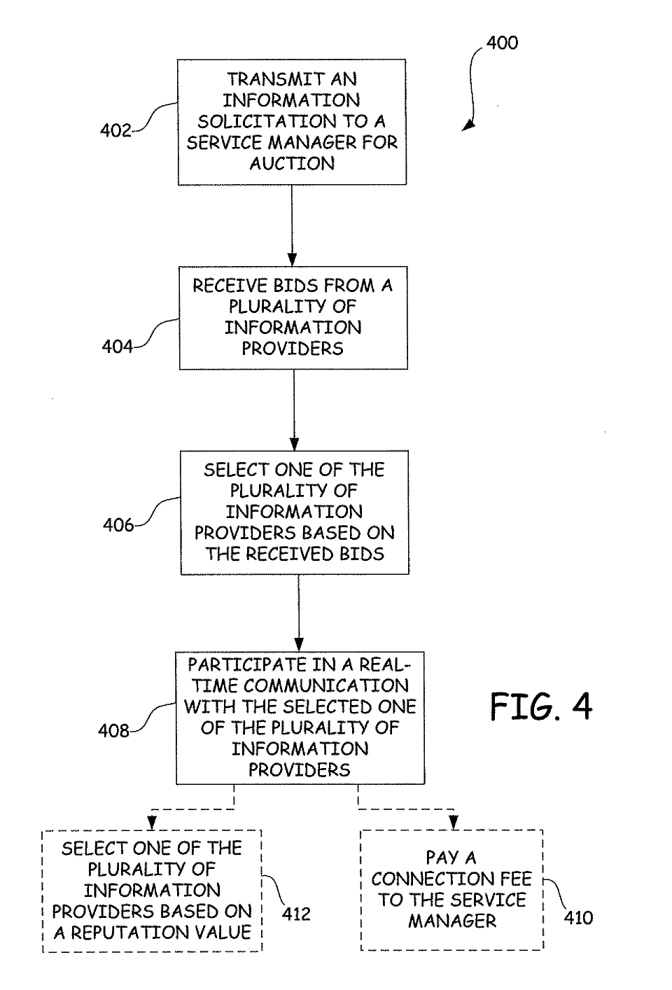

In another embodiment, FIG. 4 is a flowchart illustrating a method of soliciting information in a network-base service environment 100 (FIG. 1) of users. In accordance with this embodiment, an information consumer using a client device, such as computing device 202 or phone 204 (FIG. 2) are configured to perform the steps illustrated in FIG. 4. At block 402, the client device transmits an information solicitation to service manager 216 for auction. The information solicitation includes a request to engage in a real-time communication with an information provider about a particular subject. As previously discussed, the information solicitation transmitted by the information consumer can include at least one constraint. Constraints included with the information solicitation provide the information consumer with a mechanism to limit different types of information providers that can bid on the information solicitation. Detailed examples of constraints were given above.

At block 404, the client device receives bids from a plurality of information providers. The bids received from the information providers can be in the form of a variety of different payment methods. For example, the information provider can bid to engage in a real-time communication with the information consumer for a particular rate (i.e. $1.00/minute, $0.90/minute, $0.50/minute, etc.). In another example, the information provider can bid to engage in a real-time conversation with the information consumer for a flat fee (i.e. $20, $10, $5, etc.). These fees reflect what the information provider is willing to be compensated in exchange for partaking in a real-time communication with the information consumer about a particular subject.

At block 406, the client device selects one of the plurality of information providers based on the received bids. At block 408, the client device participates in the real-time communication with the selected one of the plurality of information providers. As previously discussed, real-time communication can be connected through a POTS interface 208 which would allow the information consumer and the information provider to have a real-time voice conversation on a telephone or cell phone. As also previously discussed, real-time communication can be connected through an IP interface 206. For example, IP interface 206 can provide real-time voice through a voice over Internet protocol (VOIP) source, a real time text using instant messaging (IM) or real time video and audio, such as videoconferencing.

As also previously discussed, each real-time connection made by connection module 214 can be an anonymous connection. An anonymous connection allows both the information consumer and the information provider to be unaware of the identification of each other. Although the information consumer and the information provider are registered with service agent 120 and identified in personal information and preferences depository 222, connection module 214 allows the information consumer and the information provider to connect while being unaware of each others identification.

At block 410, the client device pays a connection fee to service manager 216. As previously discussed, the connection fee is paid prior to participating in the real-time communication with the selected one of the plurality of information providers. At block 412, the client device selects one of the plurality of information providers based on a reputation value. As previously discussed, service manager 216 collects an information consumer review from the information provider after disconnection from the real-time communication made by connection module 214. Service manager 216 also collects an information provider review from the information consumer after disconnection from the real-time communication made by connection module 214. Service manager 216 can provide incentives to information consumers and information providers who submit information provider reviews and information consumer reviews. Service manager 216 uses the information consumer reviews to evaluate information consumers and assign each information consumer with a reputation value. Service manager 216 uses the information provider reviews to evaluate the information providers and assign each information provider a reputation value.

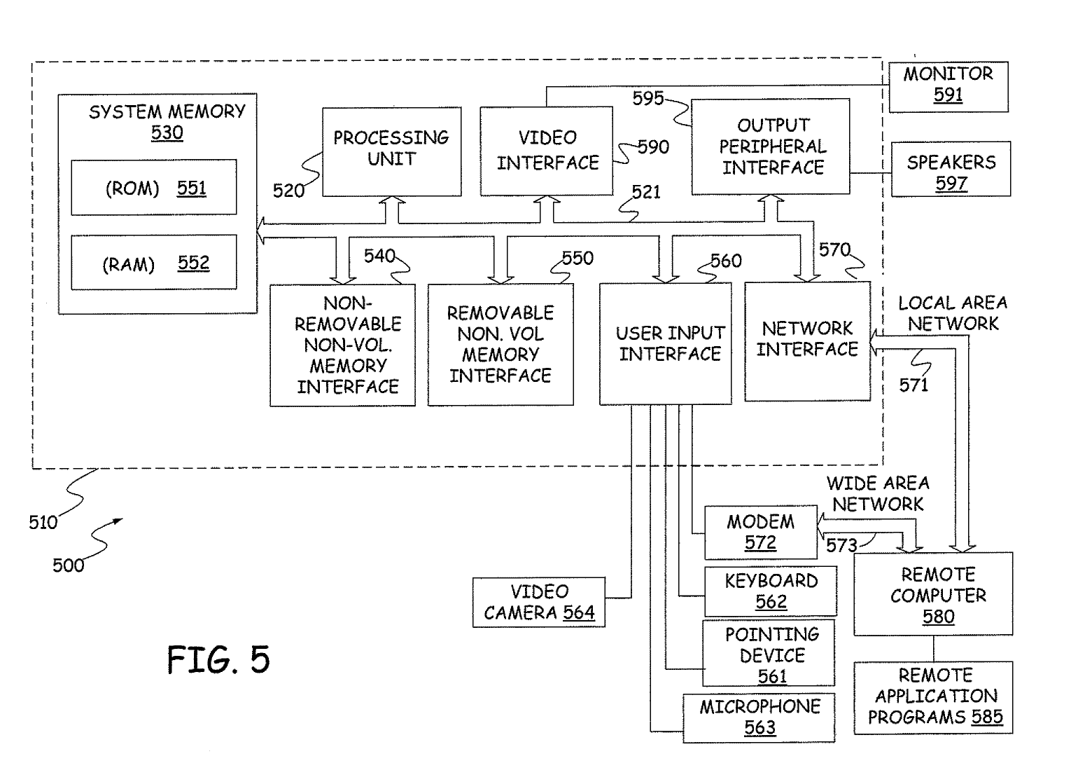

The above description of illustrative embodiments is described in accordance with a network-based service environment having a service agent and client devices. Below are suitable computing environments that can incorporate and benefit from these embodiments. The computing environment shown in FIG. 5 is one such example that can be used to implement the service agent and/or be implemented as a client device.

In FIG. 5, the computing system environment 500 is only one example of a suitable computing environment and is not intended to suggest any limitation as to the scope of use or functionality of the claimed subject matter. Neither should the computing environment 500 be interpreted as having any dependency or requirement relating to any one or combination of components illustrated in the exemplary computing environment 500.

Computing environment 500 illustrates a general purpose computing system environment or configuration. Examples of well-known computing systems, environments, and/or configurations that may be suitable for use with the service agent or a client device include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Embodiments may be described in the general context of computer-executable instructions, such as program modules, being executed by a computer. Generally, program modules include routines, programs, objects, components, data structures, etc. that perform particular tasks or implement particular abstract data types. Some embodiments are designed to be practiced in distributed computing environments where tasks are performed by remote processing devices that are linked through a communications network. In a distributed computing environment, program modules are located in both local and remote computer storage media including memory storage devices.

Exemplary environment 500 for implementing the above embodiments includes a general-purpose computing system or device in the form of a computer 510. Components of computer 510 may include, but are not limited to, a processing unit 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 510 typically includes a variety of computer readable media. Computer readable media can be any available media that can be accessed by computer 510 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data.

The system memory 530 includes computer storage media in the form of volatile and/or nonvolatile memory such as read only memory (ROM) 531 and random access memory (RAM) 532. The computer 510 may also include other removable/non-removable volatile/nonvolatile computer storage media. Non-removable non-volatile storage media are typically connected to the system bus 521 through a non-removable memory interface such as interface 540. Removable non-volatile storage media are typically connected to the system bus 521 by a removable memory interface, such as interface 550.

A user may enter commands and information into the computer 510 through input devices such as a keyboard 562, a microphone 563, a pointing device 561, such as a mouse, trackball or touch pad, and a video camera 564. These and other input devices are often connected to the processing unit 520 through a user input interface 560 that is coupled to the system bus, but may be connected by other interface and bus structures, such as a parallel port or a universal serial bus (USB). A monitor 591 or other type of display device is also connected to the system bus 521 via an interface, such as a video interface 590. In addition to the monitor, computer 510 may also include other peripheral output devices such as speakers 597, which may be connected through an output peripheral interface 595.

The computer 510, when implemented as a client device or as a service agent, is operated in a networked environment using logical connections to one or more remote computers, such as a remote computer 580. The remote computer 580 may be a personal computer, a hand-held device, a server, a router, a network PC, a peer device or other common network node, and typically includes many or all of the elements described above relative to the computer 510. The logical connections depicted in FIG. 5 include a local area network (LAN) 571 and a wide area network (WAN) 573, but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other means for establishing communications over the WAN 573, such as the Internet. The modem 572, which may be internal or external, may be connected to the system bus 521 via the user input interface 560, or other appropriate mechanism. In a networked environment, program modules depicted relative to the computer 510, or portions thereof, may be stored in the remote memory storage device. By way of example, and not limitation, FIG. 5 illustrates remote application programs 585 as residing on remote computer 580. It will be appreciated that the network connections shown are exemplary and other means of establishing a communications link between computers may be used.

Besides computer 510 being used as a client device, mobile devices can also be used as client devices. Mobile devices can be used in various computing settings to utilize service agent 216 across the network-based environment. For example, mobile devices can interact with service agent 216 using natural language input of different modalities including text and speech. The mobile device as discussed below is exemplary only and is not intended to limit the present invention described herein.

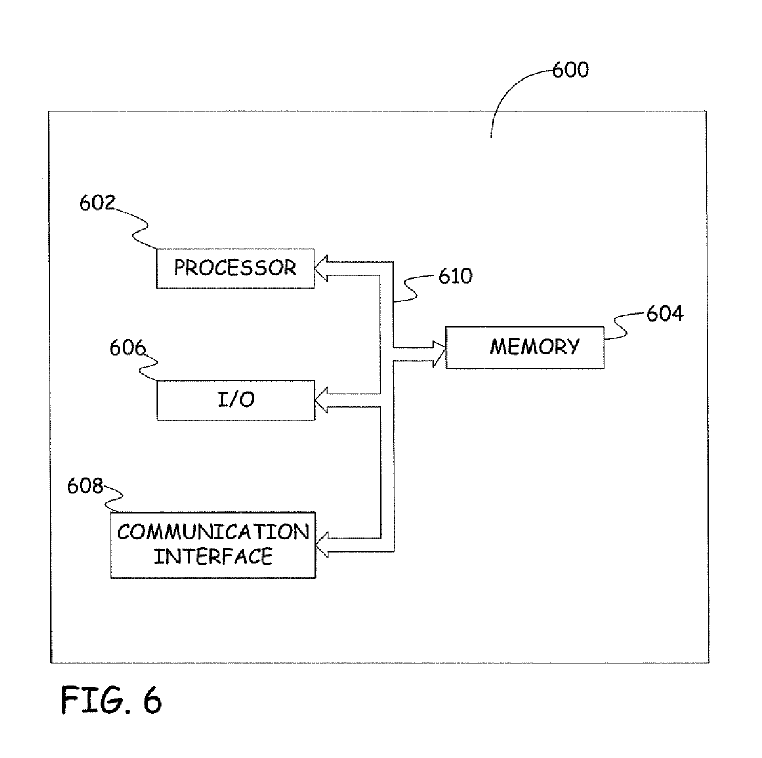

FIG. 6 is a block diagram of a data management mobile device 600, which is an exemplary client device for the network-based service environment 100. Mobile device 600 includes a microprocessor 602, memory 604, input/output (I/O) components 606, and a communication interface 608 for communicating with remote computers or other mobile devices. In one embodiment, the aforementioned components are coupled for communication with one another over a suitable bus 610.

Memory 604 is implemented as non-volatile electronic memory such as random access memory (RAM) with a battery back-up module (not shown) such that information stored in memory 604 is not lost when the general power to mobile device 600 is shut down. A portion of memory 604 is preferably allocated as addressable memory for program execution, while another portion of memory 604 is preferably used for storage, such as to simulate storage on a disk drive.

Communication interface 608 represents numerous devices and technologies that allow mobile device 600 to send and receive information. The devices include wired and wireless modems, satellite receivers and broadcast tuners to name a few. Mobile device 600 can also be directly connected to a computer to exchange data therewith. In such cases, communication interface 608 can be an infrared transceiver or a serial or parallel communication connection, all of which are capable of transmitting streaming information.

Input/output components 606 include a variety of input devices such as a touch-sensitive screen, buttons, rollers, and a microphone as well as a variety of output devices including an audio generator, a vibrating device, and a display. The devices listed above are by way of example and need not all be present on mobile device 600. In addition, other input/output devices may be attached to or found with mobile device 600.

Mobile device 600 can also include an optional recognition program (speech, DTMF, handwriting, gesture or computer vision) stored in memory 604. By way of example, in response to audible information, instructions or commands from a microphone provides speech signals, which are digitized by an A/D converter. The speech recognition program can perform normalization and/or feature extraction functions on the digitized speech signals to obtain intermediate speech recognition results. Similar processing can be used for other forms of input. For example, handwriting input can be digitized with or without pre-processing on device 600. Like the speech data, this form of input can be transmitted to a server for recognition wherein the recognition results are returned to at least one of the device 600 and/or a remote agent. Likewise, DTMF data, gesture data and visual data can be processed similarly. Depending on the form of input, device 600 would include necessary hardware such as a camera for visual input.

Mobile device 600 can also function as a plain old telephone. A phone includes a display and a keypad. Mobile device 600 can require additional circuitry to perform telephone functions. For instance, a transceiver is necessary to operate the mobile device as a phone.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of managing information solicitations in a network of users, the method comprising:
posting an information solicitation received from an information consumer that is provided to at least a portion of the users of the network for auction, wherein the information solicitation includes a request to engage in a real-time communication with an information provider about a particular subject;
receiving bids from a plurality of information providers and providing the bids to the information consumer for selection; and
connecting the information consumer with a selected one of the plurality of information providers in the real-time communication.

2. The method of claim 1, wherein connecting the information consumer with the selected one of the plurality of information providers comprises connecting the information consumer with the selected one of the plurality of information providers with a plain old telephone system (POTS) interface.

3. The method of claim 1, wherein connecting the information consumer with the selected one of the plurality of information providers comprises connecting the information consumer with the selected one of the plurality of information providers with an Internet Protocol (IP) interface.

4. The method of claim 1 wherein connecting the information consumer with the selected one of the plurality of information providers comprises connecting the information consumer with the selected one of the plurality of information providers as an anonymous connection.

5. The method of claim 1, further comprising managing a reputation of the information provider by:
collecting an information provider review from the information consumer after disconnection from the real-time communication;
providing the information provider with a reputation value based on the collected reviews and
revealing the reputation value of the information provider to the users of the network.

6. The method of claim 1, further comprising managing the reputation of the information consumers by:
collecting an information consumer review from the information provider after disconnection from the real-time communication;
providing the information provider with a reputation value based on the collected reviews; and
revealing the reputation value of the information consumer to the users of the network.

7. The method of claim 1, wherein posting the information solicitation comprises posting the information solicitation having at least one consumer constraint on a type of information provider the information consumer will accept bids from.

8. The method of claim 1, further comprising making the information solicitation available to a portion of the information providers in the network that will consider the information solicitation based on at least one constraint.

9. The method of claim 1, further comprising charging a connection fee to the information consumer, wherein the connection fee is charged to the information consumer prior to connecting the information consumer with a selected one of the plurality of information providers.

10. The method of claim 1, further comprising charging a membership fee to the information provider to permit the information provider to bid on the information solicitation.

11. The method of claim 1, further comprising charging a percentage of a value of the selected bid.

12. The method of claim 1, further comprising accessing an advertisement service to feed the information consumer and the information provider advertising during the posting, receiving and connecting steps.

13. A system for managing information solicitations in a community environment, the system comprising:
a service manager configured to:
receive an information solicitation from an information consumer and provide the information solicitation to at least a portion of the users of the network for auction, the information solicitation includes a request to engage in a real-time communication with an information provider about a particular subject;
receive bids from a plurality of information providers;
provide the bids to the information consumer for selection; and
a connection module configured to connect the information consumer with a selected one of the plurality of information providers in the real-time communication.

14. The system of claim 13, wherein the connection module connects the information consumer with the information provider using an IP interface.

15. The system of claim 13, wherein the connection module connect the information consumer with the information provider using a POTS interface.

16. The system of claim 13, further comprising an advertisement service configured to provide the information consumer and the information provider with advertisements while the information consumer and the information provider receive the information solicitation, receive bids and connect.

17. A method of soliciting information in a community environment, the method comprising:
transmitting an information solicitation to a service manager for auction, the information solicitation including a request to engage in a real-time communication with an information provider about a particular subject;
receiving bids from a plurality of information providers;
selecting one of the plurality of information providers based on the received bids; and
participating in the real-time communication with the selected one of the plurality of information providers.

18. The method of claim 17, wherein selecting one of the plurality of information providers based on the received bids further comprises selecting one of the plurality of information providers based on a reputation value.

19. The method of claim 17, wherein transmitting the information solicitation to the service manager for auction comprises transmitting the information solicitation including at least one information consumer constraint on a type of information provider that the information solicitation can be provided.

20. The method of claim 17, further comprising paying a connection fee to the service manager prior to participating in the real-time communication with the selected one of the plurality of information providers.
